(19) United States
(12) Patent Application Publication
(10) Pub. No.: US 2026/0370638 A1
(43) Pub. Date: Nov. 19, 2026

(54) SYSTEMS AND METHODS FOR GENERATING EPHEMERAL API ENDPOINTS

(71) Applicant: Adeia Guides Inc., San Jose, CA (US)

(72) Inventor: Ning Xu, Irvine, CA (US)

(21) Appl. No.: 19/211,783

(22) Filed: May 19, 2025

(51) Int. Cl. H04L 9/40; G06F 9/54

(52) U.S. Cl. CPC H04L 63/0823; G06F 9/547

(57) ABSTRACT

The present application provides for generating ephemeral API endpoints. A server-side orchestration agent receives, from a client-side orchestration agent, requirements for a task from a client device. The server-side orchestration agent identifies, based on the requirements, available computing resources for performing the task. The server-side automatically generates computer-executable code for performing the one or more components of the task and instantiates an API server by executing the generated computer-executable code for accessing the computing resources. The server-side orchestration agent transmits, to the client device, identification of a supported methods of the API server. The server-side orchestration agent determines a time period based on the requirements for the task or the availability of the computing resources and then causes a certificate authority to issue an ephemeral certificate for the determined time period.

### BACKGROUND

This disclosure is related to systems and methods for generating ephemeral application programming interfaces (APIs), more particularly generating ephemeral API endpoints using artificial intelligence orchestrated negotiation.

### SUMMARY

Conventional software systems heavily rely on APIs to enable communication between services, microservices, clients, and user agents. The proliferation of large language model (LLM)-based AI agents, such as those built on OpenAI's GPT-4 platform, has created a new dimension of interaction with APIs. These AI agents are increasingly deployed on the client-side, utilizing APIs to perform tasks such as data analysis, decision-making, and real-time communication with other services.

The need for dynamic APIs arises because these AI agents often deal with highly variable, context-specific tasks. For example, an LLM-based assistant may need to query a specific genre of movies that has certain actors on a media platform, and the task might require different API functionalities, schemas, and access policies rather than static APIs that are provided by the platform. Additionally, in some approaches LLM-based agents may benefit from the ability to write and execute code on both the client-side and server-side. This means that the client-side agents may dynamically generate new application logic that may have support from new, previously non-existent APIs. On the server-side, another LLM-based agent can communicate with the client-side agent to determine the specific need, generate the required API code, and deploy the API. This interaction enables a coordinated approach where the client-side agent articulates its requirements, and the server-side agent dynamically provisions the API with the necessary functionality and security measures.

In some software systems, API endpoints are created manually or require significant configuration overhead, delaying feature rollouts or specialized client solutions. In one approach, tools such as a Dynamic JSON API Generator aid in static API generation by creating predefined endpoints based on user input. While this approach simplifies the creation of static APIs, it does not support ephemeral API generation or the dynamic negotiation process between client and server agents. Thus, this approach does not implement real-time customization and automated API provisioning in response to unique client demands.

Another approach implements agent endpoints which provide ephemeral tunneling solutions. In this approach, local servers may provide temporary access to the internet for testing and debugging purposes. However, this approach for using agent endpoints is designed for static services and lacks the ability to dynamically orchestrate containerized microservices or generate short-lived security certificates. This limitation makes it unsuitable for scenarios requiring secure, task-specific ephemeral APIs as described herein.

In yet another approach, an API generator automates CREATE, READ, UPDATE, and DELETE (CRUD) microservice generation using predefined configurations and schemas. While this approach reduces manual effort for static API development, it lacks on-demand lifecycle management and the capability for real-time client/server negotiation. This restricts its ability to support the adaptive, task-specific requirements of LLM-based agents. Thus, the aforementioned approaches, while addressing some aspects of API creation and management, fail to provide the level of automation, security, and flexibility required for the dynamic, ephemeral API provisioning that LLM-based agents demand.

To help address these problems, systems and methods are provided herein for generating ephemeral API endpoints using artificial intelligence orchestrated negotiation. In some embodiments, a server-side orchestration agent may receive, from a client-side orchestration agent, requirements for a task of a client device. For example, a chatbot interface (e.g., client-side) interacting with a user on a tablet device may receive a task. For example, the task may be to generate a video feed exclusively tracking one player in a soccer match that they are watching.

The server-side orchestration agent may identify, based on the requirements, available computing resources (e.g., control circuitry, processing circuitry, memory, and/or network connectivity) for performing the task. Continuing with the example, the server-side orchestration agent may determine that it has one virtual CPU and GPU, as well as available bandwidth to allocate for this task. The server-side orchestration agent may automatically generate computer-executable code for performing the one or more components of the task, and then may instantiate an API server by causing at least one agent to execute the generated computer-executable code that accesses the computing resources. The agents may be implemented via one or more AI models (e.g., LLM models, multi-modal models, etc.) Continuing with the example, the server-side orchestration agent may instantiate an API server to interface with a video feed from ESPN for the soccer match, and generate code for the CPU that includes or utilizes a computer vision algorithm to detect the player from the EPSN video feed for the soccer match. The server-side orchestration agent may transmit, to the client device, identification of a supported method of the API server (e.g., API calls such as a GET method related to at least one endpoint of the API server). The server-side orchestration agent may determine a time period based on the requirements for the task or the availability of the computing resources, and then cause a certificate authority to issue an ephemeral certificate for the determined time period. The client device may only access the API server during the determined time period. For example, the server-side orchestration agent may determine the time period is 1.5 hours to fully capture the soccer match based on the task requirements with the time limit of the soccer match will not exceed 1.5 hours, and cause the certificate authority to issue an ephemeral certificate for the user's tablet device to access the API server for the 1.5 hours.

The systems and methods describe herein provide for the server-side orchestration agent to provide a level of automation with a plurality of other AI agents (e.g., client-side orchestration agents, API agents, certificate authorities, etc.) to efficiently perform the task while mitigating security risk with ephemeral endpoints related to the time period of the task. Leveraging AI models for the plurality of AI agents, this automated ephemeral API generation lifecycle management allows for a variety of microtasks to be generated and performed to fulfil the requirements of the overall task. By issuing short-lived security certificates and tightly integrating lifecycle management (e.g., API termination provision), the system ensures that each API instance remains secure, resource-efficient, and strictly time-bound. In operation, the client-side AI agent communicates its requirements to a server-side orchestration agent, which then generates an API specification including endpoint definitions, access policies, and security parameters. The orchestration agent launches containerized services or serverless functions that implement this generated specification on demand—dynamically and automatically generating new APIs and terminating them once the requested tasks are completed or the time period (e.g., based on usage) expires. This ephemeral approach not only eliminates unnecessary overhead seen in continuously running services but also reduces attack surfaces through transient certificate issuance and strict access controls.

In some embodiments, the server-side may monitor for an API call to the API server. If no API call(s) related to the task are made to the API server within a particular period of time, the server-side may cause the certificate authority to revoke the ephemeral certificate before expiration of the determined time period. For example, if the client device does not react or respond to the soccer match for 30 minutes after providing the exclusive player video feed, the server-side may revoke the ephemeral certificate as it is likely the user is no longer watching the soccer match, and the security certificate need not be active. In other embodiments, the server-side may identify unauthorized API calls to the API server, and revoke the ephemeral certificate before expiration of the determined time period. For example, if a different device other than the client device attempts to access the API server to watch the soccer match with the exclusive player stream, the server-side may cause the certificate authority to revoke the ephemeral certificate. In yet other embodiments, the server-side may, based on an expiration of the time period, terminate the API server and cause the certificate authority to terminate the ephemeral certificate. Thus, the systems and method described herein provide for automated API lifecycle management to provide custom services for client devices while ensuring high security with multiple criteria (e.g., time-period, lack of active participation) to trigger termination of the ephemeral API.

In some embodiments, the client device may receive a user interface (UI) input specifying a prospective component of the task (e.g., camera feed must be on a player the entire time), and then receive an indication from the server-side that there is a lack of computing resources to complete this prospective component of the task (e.g., two Intel core i9s are required instead of one Intel core i9). An altered prospective component of the task is generated (e.g., camera feed may be on player greater than 80% of the match), and a UI confirmation is received to proceed with the altered prospective task. In some embodiments, when the server-side executes the computer-executable code that causes accessing of the computing resources, it may identify a lack of computing resources for the task and transmit a request for an additional server-side orchestration agent on an additional server to instantiate an additional API server to provide additional resources. Continuing with the example above where two Intel core i9s were required, the server-side may request an additional server-side orchestration agent on an additional server that has computing resources equivalent to another Intel core i9.

In some embodiments, the server-side may store the generated computer-executable code in a database, and access, through the client-side, second requirements for a second task from a second client device. The server-side may identify, based on the second requirements, a second set of computing resources available to the server-side to perform the second task. A determination may be made by the server-side as to whether the second requirements for the second task match the generated computer-executable code in the database. If so, the server-side may retrieve the matching generated computer-executable code from the database and instantiate a second API server by causing an agent to execute the stored computer-executable code. For example, the task may be to create a video feed to track a player exclusively for the duration of the soccer match. The generated computer-executable code for the text is stored within a database. The second task may be to track a different player for the duration of the same soccer match. A determination is made as to whether the requirements are matching. Although the player is different, the schema and algorithm for the stored computer-executable code may be used to perform this second task with minor alterations. The code is retrieved, and minor adaptations are made to account for the different player. Finally, a second API server is instantiated by executed the retrieved and adapted code.

### BRIEF DESCRIPTION OF THE DRAWINGS

The present disclosure, in accordance with one or more various embodiments, is described in detail with reference to the following figures.

FIG. 1A shows an illustrative scenario in which a client-side orchestration agent negotiates requirements of a task from a client device, in accordance with some embodiments of this disclosure.

FIG. 1B shows an illustrative scenario in which a server-side orchestration agent identifies computing resources for the task, in accordance with some embodiments of this disclosure.

FIG. 1C shows an illustrative scenario in which a server-side orchestration agent instantiates an API server to perform the task, in accordance with some embodiments of this disclosure.

FIG. 1D shows an illustrative scenario in which an API server provides a collated stream to the client device, in accordance with some embodiments of this disclosure.

FIG. 1E shows an illustrative scenario in which a server-side orchestration agent terminates the execution of the API server and transmits instructions to revoke the certificate for the API server, in accordance with some embodiments of this disclosure.

FIG. 2 shows an illustrative scenario in which the system instantiates an API server to create a heatmap during an esports gaming stream, in accordance with some embodiments of this disclosure.

FIG. 3 shows an illustrative scenario in which the system instantiates an API server to create a single storefront for a plurality of ecommerce-based storefronts, in accordance with some embodiments of this disclosure.

FIG. 4 shows an illustrative scenario in which the system instantiates an API server to create a customized video feed for a sports match, in accordance with some embodiments of this disclosure.

FIG. 5 is a sequence diagram in which the system provides an ephemeral security certificate for an API server while providing customized content to a client device, in accordance with some embodiments of this disclosure.

FIG. 6 shows illustrative user equipment devices, in accordance with some embodiments of this disclosure.

FIG. 7 shows illustrative systems, in accordance with some embodiments of this disclosure.

FIG. 8 is a flowchart of a detailed illustrative process for causing a certificate authority to issue an ephemeral certificate for the determined time period during instantiation of an API server, in accordance with some embodiments of this disclosure.

Drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting example embodiments and that the scope of the present invention is defined solely by the claims.

### DETAILED DESCRIPTION

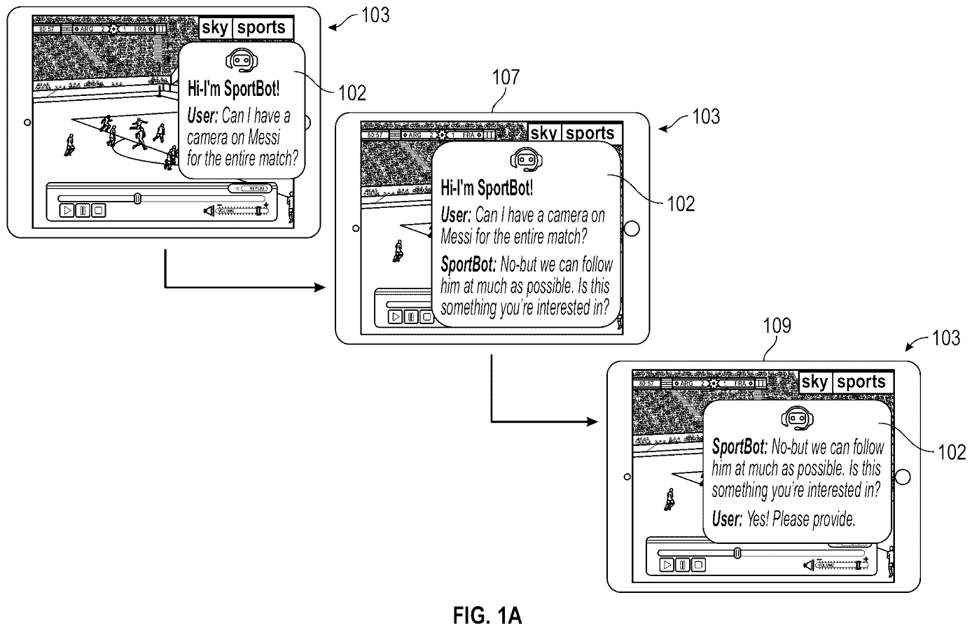

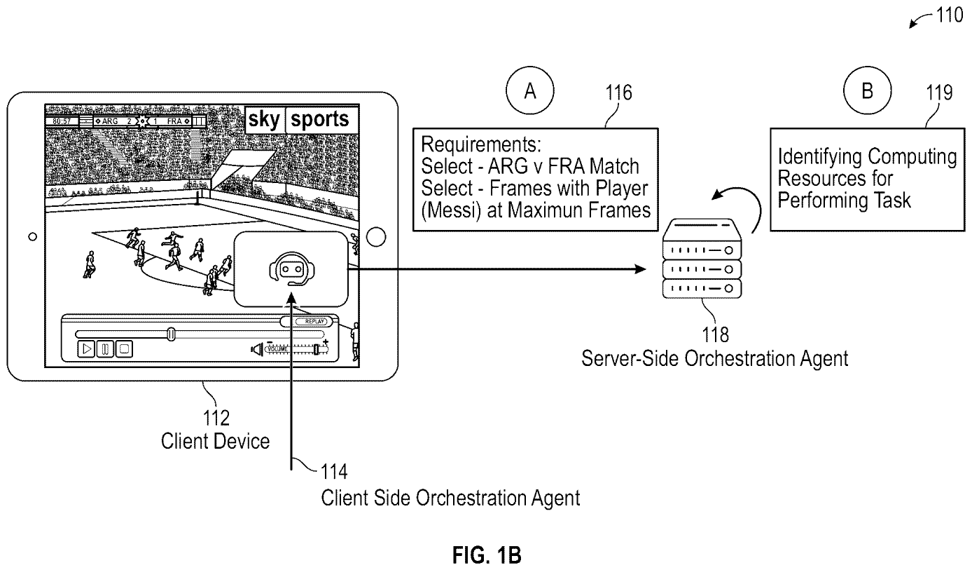

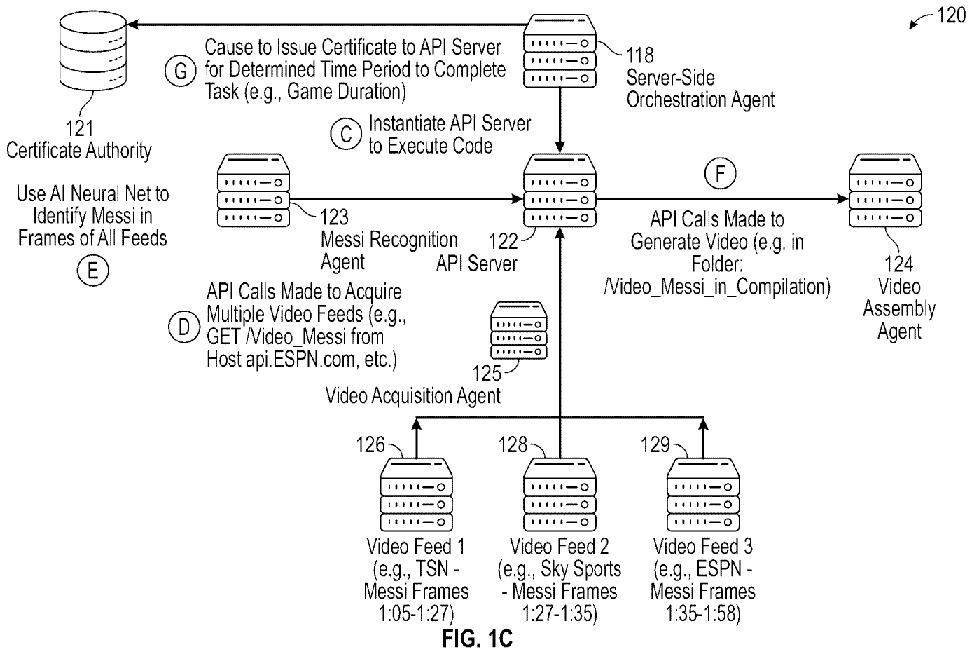

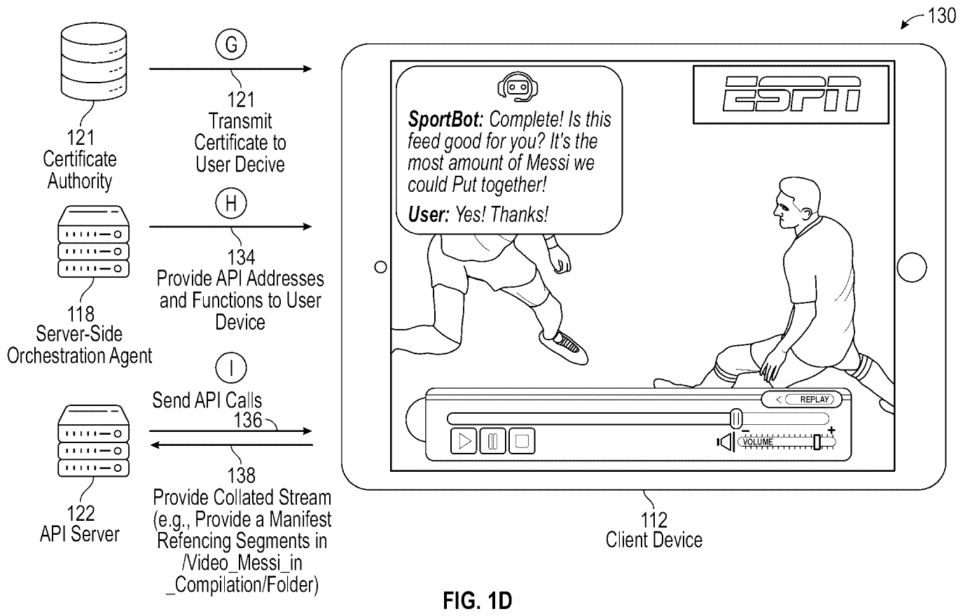

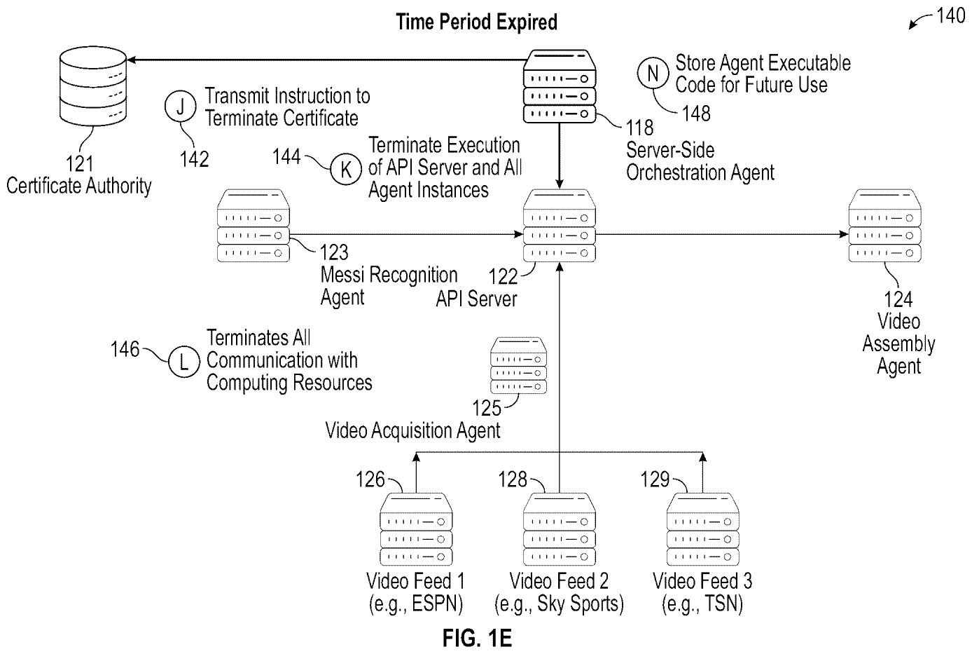

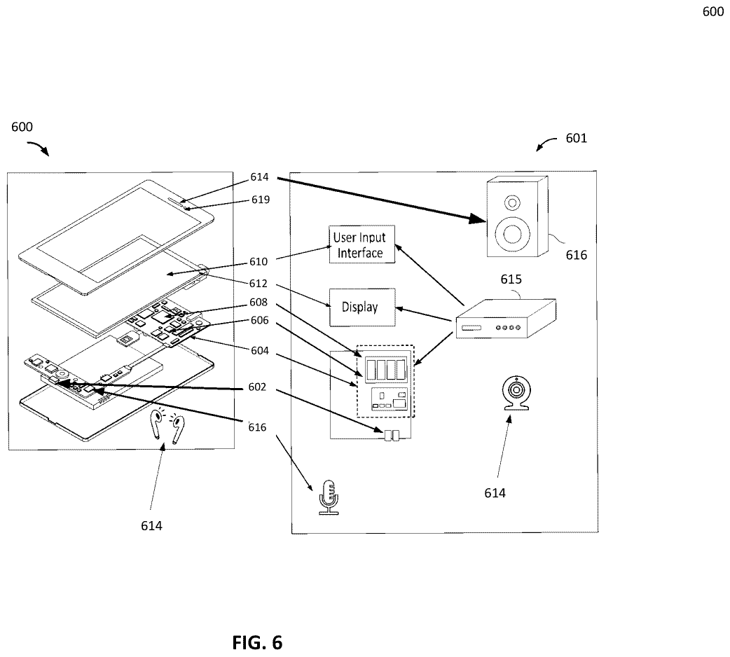

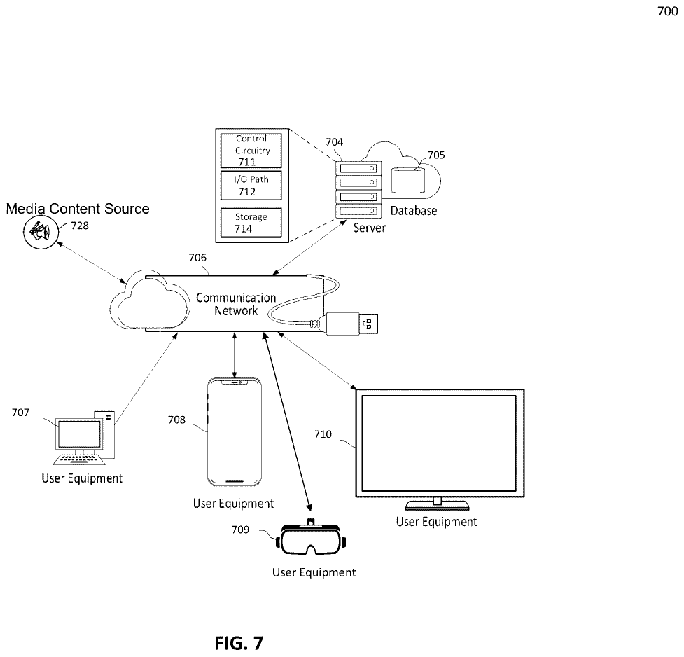

FIG. 1A shows an illustrative scenario 100 in which a client-side orchestration agent 102 negotiates requirements of a task from a client device 103, in accordance with some embodiments of this disclosure. A server-side orchestration agent may receive from a client-side orchestration agent, requirements for a task of a client device. The requirements may be acquired using an interface (e.g., a conversational AI system, or other type of interface). The client-side orchestration agent and server-side orchestration agents may be any suitable computing device with control circuitry and processing circuitry that is network connected to one or more entities to transmit and receive data in relation to creating customizable content to client devices based on artificial intelligence orchestrated negotiation. For example, the client-side orchestration agent may be the user equipment illustrated and described in FIG. 6-7.

Returning to FIG. 1A, the client-side orchestration agent 102 is a conversational AI system (e.g., a chatbot) that utilizes one or more I/O interfaces to receive instruction from the client device 103. In some embodiments, the I/O interfaces may include text input interfaces, voice input interfaces, touch input, mouse input, controller input, and/or other suitable interfaces for input and/or output. In this case, the client-side orchestration agent may be integrated into the Sky Sports network application. In some embodiments, the client-side orchestration agent may be a third-party application that overlays onto a broadcast stream which may be provided by Sky Sports, ESPN, TSN, and the like. At 105, the client-side orchestration agent 102 receives textual input from the client device (e.g., tablet) stating that “Can I have a camera on Messi for the entire match?” in relation to a soccer match that includes the player Lionel Messi. At 107, the chatbot 102 negotiates the requirements with the client device 103 to state “No-but we can follow him at much as possible. Is this something you're interested in?” At 109, the client device 103 accepts the revised requirements proposed by the chatbot 102. In some embodiments, the client-side orchestration agent, when negotiating the requirements, may determine the available computing resources via the server-side orchestration agent (as shown later in FIG. 1B at 119) before transmitting negotiated requirements to the client device. In some embodiments, the negotiation is based on local analysis by client-side orchestration agent. In some embodiments, the negotiation is based on communication between client-side orchestration agent and the server side orchestration agent. For example, when determining the number of frames containing Messi in the available streams from Sky Sports, ESPN, and TSN, the server-side orchestration agent determines that there cannot be a collated stream for the entire duration of the match that has Messi within the frame, instead the closest to this goal is 79% of the duration of the match with Messi in frame. In some embodiments, the negotiation of requirements may be based on available computing resources. In other embodiments, the negotiation of requirements may be based on available content requested (e.g., there may not be a camera feed of Messi on any available broadcast of the soccer match). In some embodiments, the client-side orchestration agent may implement large language model (LLM) based multi-agents or equivalent AI model that determines context-specific requirements for the API. In some embodiments, the client-side orchestration agent may be implemented on the client device (e.g., a mobile device, browser, or local application) and acts as the primary interface for API demand articulation. The client-side orchestration agent may engage in bi-directional negotiation with the server-side AI agent to refine API specifications, required endpoints, data models, and security levels.

The server-side orchestration agent may identify, based on the requirements, computing resources available to the server-side orchestration agent for performing one or more components of the task. For example, the computing resources may be control circuitry, processing circuitry, memory, needed data sources, and/or network connectivity to perform at least one or more components of the task. Computing resources may further include the amount of processing (e.g., CPU or GPU usage), the amount of network performance that may include bandwidth, quality of service metrics, signal strength, and other computing resources required to perform the task. FIG. 1B shows an illustrative scenario 110 in which a server-side orchestration agent 118 identifies computing resources for the task, in accordance with some embodiments of this disclosure. The server-side orchestration agent 118 receives the requirements 116 from the client-side orchestration agent 114 that negotiated the requirements with the client device 112. The requirements are specified to select the France versus Argentina match and select the maximum number of frames of this match for the player “Messi.” The server-side orchestration agent 118 identifies the computing resources for performing this task specified by the requirements. In some embodiments, the server-side orchestration agent processes end-to-end API lifecycle management, from negotiation, development, to deployment and termination. This may include the provisioning of containerized microservices (e.g., sub-agents created by an API server) or serverless functions to implement the API specification (e.g., an agent-to-agent communication). The server-side orchestration agent may coordinate with the API development agent to handle API code generation, data and resource integration, and security configuration. In some embodiments, the server-side orchestration agent may implement LLM based multi-agents or equivalent AI model that interprets requests from the client-side agent and evaluates their feasibility. In some embodiments, the server-side orchestration agent may implement a sub-agent (e.g., a server-side AI agent) to negotiate parameters such as access policies, data models, and security and generate the API specifications in real-time. In some embodiments, the server-side AI agent may assess data availability, computational resource constraints, and backend service dependencies, adapting API specifications based on system constraints and available resources. Continuing with the example in FIG. 1A-E, available resources for the stream of the FRA vs. ARG match include three distinct broadcast streams from Sky Sports, EPSN, and TSN as shown in FIG. 1C, and use this information to adapt the API specification to firstly negotiate with the client device that only these source may be used, then implementing these sources through various agents to eventually collate the frames that contain Messi and provide the collation to the client device. In some embodiments, a single broadcast stream may include a plurality of camera feeds having the ability to select and switch each respective camera feed. Although the broadcast stream may select one of the plurality of camera feeds to generate for continuous display, the API agent may be able to select any of the respective camera feeds from the broadcast stream depending on the API specifications.

The server-side orchestration agent may automatically generate computer-executable code for performing the one or more components of the task. Automatic generation may refer to the generation of computer-executable code without receiving a user input to commence or control generation of the computer-executable code. Automatic generation may refer to the generation of computer-executable code made autonomously from an AI agent. The server-side orchestration agent may instantiate an API server by causing at least one agent to execute the generated computer-executable code. The execution of the computer-executable code may cause accessing of the identified computing resources. FIG. 1C shows an illustrative scenario 120 in which a server-side orchestration agent implements an API server to perform the task, in accordance with some embodiments of this disclosure. The server-side orchestration agent 118 may instantiate an API server 122 to execute the computer-executable code to generate the custom video feed of the player Messi in the soccer match. In some embodiments, the API server may be part of the server-side orchestration agent (e.g., the API server may be computer-executable code implemented by the server-side orchestration agent). The API server 112 may implement a video acquisition agent 125 to retrieve a plurality of video feeds (e.g., video feed 1 (126), video feed 2 (128), and video feed 3 (129)) of the soccer match. The API server may interface with the plurality of video feeds via API calls such as a GET API call that may specify, for example: GET /video_messi from host api. ESPN. com which may be a manifest having addresses of the specific segments of the ESPN stream that have Messi frames. The implementation of the video acquisition agent, or any other agent by the API server 122, may be implemented via computer-executable code. In some embodiments, the agents may be submodules (or subroutines) of the server implementation. In yet other embodiments, the agents may be disparate hardware relative to the server implementation. The API server 122 may implement a Messi recognition agent 123 that includes one or more neural networks (e.g., convolutional neural networks) to identify Messi from one or more frames taken from the video acquisition agent 125. In some embodiments, the Messi Recognition Agent may implement an AI discriminator that is trained to identify the names on the back of players jerseys in the soccer match. This AI discriminator may be configured to check if the name detected matches the target Messi. The API server 122 may implement a video assembly agent 124 to generate a collation of the plurality of frames identified with Messi from the plurality of video feeds. For example, the video assembly agent may generate a manifest that contains addresses of segments for each of the plurality of video feeds that contain frames of Messi. Thus, the manifest may be used by the client device to pull those segments, from each of the plurality of available broadcast streams, that have Messi. In some embodiments, the API server may generate API endpoints based on negotiated specifications, adapting to available backend data and resources and conduct automated testing and validation, including unit testing, load testing, and security enforcement before the API is deployed. In some embodiments, the API server may deploy the API as a microservice or serverless function.

The server-side orchestration agent may transmit, to the client device, identification of at least one supported method of the API server to enable the client device to make at least one API call to the API server. The server-side orchestration agent may then determine a time period based on at least one of the requirements for the task, or availability of the computing resources. FIG. 1D shows an illustrative scenario 130 in which an API server 122 provides a collated stream to the client device, in accordance with some embodiments of this disclosure. At 134, the server-side orchestration agent 118 provides API addresses and functions to the client device 112. The functions may include at least one of a GET method related to at least one endpoint of the API server, a POST method related to at least one endpoint of the API server, a PUT method related to at least one endpoint of the API server (e.g., for server guided advertisement insertion, or for trick play control on a broadcast stream), or a DELETE method related to at least one endpoint of the API server. At 136, the client device 112 may use the API call GET to retrieve the collated stream from the API server 122. At 138, in response, the API server 122 may transmit the collated stream (e.g., a manifest with addresses of the various video segments) of the soccer match with maximum video feed of the player Messi.

The server-side orchestration agent may cause a certificate authority to issue an ephemeral certificate for the determined time period. The ephemeral certificate may provide keys required to perform various functions such as decryption, signing, and/or verification of signatures from the API server. For example, the stream provided to the client device may be encrypted, and the ephemeral certificate may be required to provide the decryption key. In another example, the provided stream to the client device may be signed, and the ephemeral certificate may provide a key to verify the signature. In another example, the certificate may provide a key needed to sign the request to the API server. The client device may be configured to use the ephemeral certificate to access the API server during the determined time period. Returning to FIG. 1D, at 132, the certificate authority 121 transmits the certificate to the client device 112 such that the client device 112 may perform the API calls (e.g., 136 and 138) only during the time period that the certificate is valid. FIG. 1E shows an illustrative scenario 140 in which a server-side orchestration agent 118 terminates the execution of the API server 122 and transmits instructions to revoke the certificate for the API server 122, in accordance with some embodiments of this disclosure. In this example, the determined time period, that is utilized by the certificate authority to issue an ephemeral certificate, has expired. At 142, the server-side orchestration agent 118 transmits instructions to the certificate authority 121 to terminate the ephemeral certificate. At 144, the server-side orchestration agent 118 may terminate the execution of the API server 122. Consequently, this terminates all agents implemented by the API server 122 (e.g., Messi recognition agent 123, video assembly agent 124, and video acquisition agent 125). At 146, consequently, the termination of the execution of the API server 122 also terminates communication with computing resources. In some embodiments, at 148, the server-side orchestration agent 118 may store the previously implemented computer-executable code for future use in a storage memory. In some embodiments, the certificate authority issues short-lived transport layer security (TLS) or secure sockets layer (SSL) certificates for each newly generated API endpoint to ensure that all endpoints have valid (but time-bound based on the time period) encryption and identity verification.

In some embodiments, the API server may monitor for at least one API call from the client device to the API server. In some embodiments, as mentioned previously, the API server may be computer-executable code implemented by the server-side orchestration agent. In other embodiments, the API server may be distinct hardware and/or software than the server-side orchestration agent that is communicatively coupled. Based on a determination that no API calls from the client device associated with the task were made to the API server for a particular period of time, the API server may cause the certificate authority to revoke the ephemeral certificate before expiration of the determined time period. In other embodiments, the API server may cause the server-side orchestration agent to revoke the ephemeral certificate before expiration of the determined time period. For example, if the user is watching the soccer match and no API calls have been initiated within the last 40 minutes, the certificate may be revoked. The particular period of time may be preset, customized based on received input, or dynamically adjusted based on monitored user input patterns. In some embodiments, the server-side orchestration agent may implement a lifecycle management module that may track usage patterns and pre-defined conditions (e.g., task completion, time expiry). The lifecycle management module may automatically terminate the ephemeral API and revoke certificates when termination conditions are met (e.g., time period has expired).

In some embodiments, the server-side orchestration agent may identify an unauthorized API call associated with the task to the API server. Based on identifying the unauthorized API call associated with the task to the API server, the server-side orchestration agent may cause the certificate authority to revoke the ephemeral certificate before expiration of the determined time period. For example, if there is an unauthorized secondary client device that transmits API calls to the API server, the certificate authority may revoke the ephemeral certificate before expiration to mitigate a potential security compromise.

In some embodiments, as shown in FIG. 1A, the server-side orchestration agent may implement a client-side orchestration agent to receive user input from the client device. The client-side orchestration agent (which may be a subroutine of the server-side orchestration agent) may receive a UI input from the client device specifying a prospective component of the task. In some embodiments, the client-side orchestration agent may be a thin client, implemented by the server-side orchestration agent via computer-executable code, that includes a UI and a generating for display of a stream to the client device. For example, the UI input may be a textual input stating “Can I have a camera on Messi for the entire match?” as stated in 105 in FIG. 1A. The server-side orchestration agent may provide an indication that there is a lack of computing resources for the prospective component of the task and transmit, to the client device, an indication indicating the lack of computing resources for the prospective component of the task. The transmission of the lack of computing resources for the prospective component of the task may cause the client device to generate a proposal of an altered prospective component of the task. This is shown in 107 in FIG. 1A where the proposal states “No-but we can follow him at much as possible. Is this something you're interested in” The client-side orchestration agent may receive a UI confirmation from the client device to proceed with the task based on the proposal of the altered prospective component of the task (e.g., “Yes! Please provide!” as per 109 of FIG. 1A). The client-side orchestration agent and server-side orchestration may negotiate with the received UI input from the client device based on the available computing resources.

In some embodiments, the server-side orchestration agent may, when executing the computer-executable code that causes accessing of the computing resources, identify a lack of computing resources for a prospective component of the task. For example, the task for analyzing the frames for Messi may require a Messi recognition agent (implemented by the API server) that requires a virtual GPU; and this hardware is not readily available. the server-side orchestration agent may transmit a request to an another server-side orchestration agent on an another server to instantiate an another API server for providing other resources. Continuing with the example, the request may be sent to a cloud-based server having a virtual GPU that is available for compute. Accessing these computing resources may include accessing other resources from the additional API server. In some embodiments, the additional server-side orchestration agent may request further support from one or more other server-side orchestration agents. This process may be recursive to ensure that a plurality of interconnected computing resources may be identified and utilized to implement the prospective component of the task (e.g., by one or more agents of the API server).

In some embodiments, the server-side orchestration agent may store the generated computer-executable code in a database. The database may be any means of storage that is available to the server-side orchestration agent such as embedded memory, network-accessible memory (e.g., database), and/or memory resources from additional server-side orchestration agents. The server-side orchestration agent may access second requirements for a second task from a second client device. This may occur in a client-side negotiation similar to FIG. 1A at 105, 107, and 109. In some embodiments, the second client device may be any one of the first client device, or one or more client devices that are distinct from the first client device. The server-side orchestration agent may identify, based on the second requirements, a second set of computing resources available to the server-side orchestration agent for performing the one or more components of the second task (e.g., similar to FIG. 1B at 116 and 119). The server-side orchestration agent may then determine whether the second requirements for the second task correspond to the generated computer-executable code in the database (e.g., similar to FIG. 1E at 148, where the server-side orchestration agent 118 may have stored the previously implemented computer-executable code for future use in a storage memory). In response to the second requirements for the second task corresponding to the generated computer-executable code in the database, the server-side orchestration agent may retrieve the generated computer-executable code in the database and instantiate a second API server by causing at least one additional agent to execute the stored computer-executable code. For example, if the second requirements (similar to those of FIG. 1B at 116) require the following:
Select—ARG v FRA match
Select—frames with player (Mbappe) at maximum frames
   In this example, various agents that were previously coded in the generated computer-executable code may be used. For example, the video acquisition agent and the video assembly agent may be utilized with minor adaptations. The Messi recognition agent may be modified to change the recognition parameters to those of Mbappe. In some embodiments, the API server may be modified to receive user input from the client device forwarded through the client-side orchestration agent and server-side orchestration agents where the received user input is a text input that includes a player name (e.g., Mbappe).

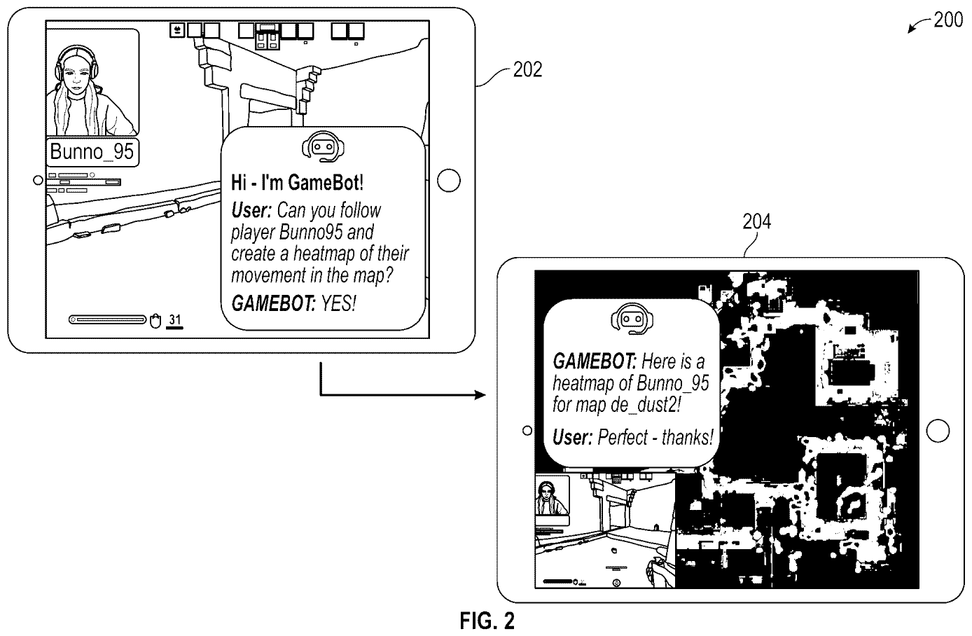

FIG. 2 shows an illustrative scenario 200 in which the system instantiates an API server to create a heatmap during an esports gaming stream, in accordance with some embodiments of this disclosure. At 202, the client-side orchestration agent may a conversational AI system (e.g., a chatbot named GameBot) that utilizes one or more I/O interfaces to receive instruction from the client device (e.g., a personal computer that is generating for display a stream of an esports game of Counter-Strike 2™. In other embodiments, client-side orchestration agent may provide any other suitable interface for making requests (e.g., a menu system with drop down and/or radio selections, a selectable list of pre-generated requests, etc.) The client-side orchestration agent receives textual input from the client device (e.g., a personal computer) stating that “Can you follow player Bunno95 and create a heatmap of their movement in the map?” in relation to the Counter-Strike 2 match that has the player Bunno95 that is being streamed to the personal computer. The server-side orchestration agent receiving these requirements would identify the computing resources (e.g., a virtual CPU), and automatically generate computer-executable code for generating the heatmap for Bunno95. The code, once automatically executed by the server-side orchestration agent, instantiates an API server and transmits to the client device supported methods of the API server (e.g., API calls). The server-side orchestration agent may determine a time period based on the length of the of the Counter-Strike 2 match (e.g., 60 minutes), and causes a certificate authority to send a certificate to the personal computer for 60 minutes to facilitate the API calls from the personal computer to the API server. The orchestration agent may generate a plurality of sub-agents that help perform the task. For example, there may be a CS_metadata agent that receives live metadata from a Counter-Strike match and a CS_virtual_camera agent that tracks players movement via a generated video feed. There may further be a CS_player_analyzer agent that receives input from the CS_metadata agent and CS_virtual_camera agent and determines the path taken by the player and how long they stayed at a particular location. A heatmap_agent may receive the analysis from the CS_player_analyzer agent and generate a heatmap based on this information. At 204, the API server transmits (via a SEND API call) the generated heatmap graphic superimposed over the stream on the client device. The client-side orchestration agent (e.g., GameBot) provides a UI textual message upon transmission of the SEND API call stating “Here is a heatmap of Bunno_95 for map de_dust2!” In some embodiments, the server-side orchestration agent may spin up short-lived APIs for dynamic overlays, spectator interactions, match data, live event tracking, and AI-driven game commentary. APIs, via the API server, are automatically scaled, secured, and retired when the match ends or data is no longer relevant, minimizing infrastructure costs.

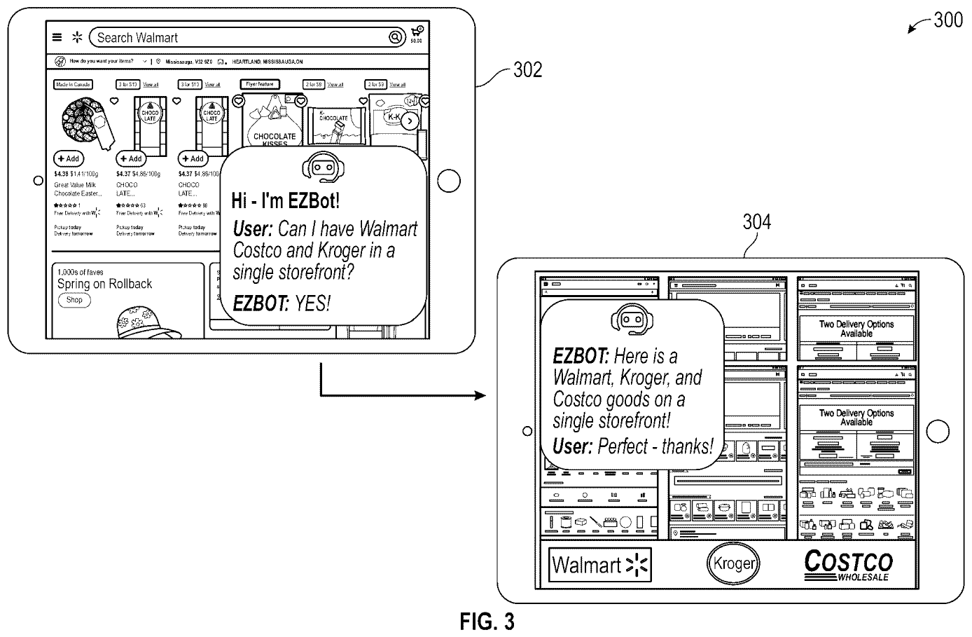

FIG. 3 shows an illustrative scenario 300 in which the system instantiates an API server to create a single storefront for a plurality of ecommerce-based storefronts, in accordance with some embodiments of this disclosure. At 302, the client-side orchestration agent is a conversational AI system (e.g., a chatbot named EZBot) that utilizes one or more I/O interfaces to receive instruction from the client device (e.g., a personal computer that is generating for display an ecommerce application for a single vendor—e.g., Walmart). The client-side orchestration agent receives textual input from the client device (e.g., a personal computer) stating that “Can I have Walmart Costco and Kroger in a single storefront?” in relation to the utilized ecommerce interface. The server-side orchestration agent receiving these requirements would identify the computing resources (e.g., a virtual CPU), and automatically generate computer-executable code for the unified ecommerce application. The code, once automatically executed by the server-side orchestration agent, instantiates an API server and transmits to the client device supported methods of the API server (e.g., API calls). The orchestration agent may implement a plurality of sub-agents to perform the task. For example, the orchestration agent may generate a store_scraper_agent that retrieves store data related to all goods and associated metadata (e.g., price, quantity, description, promotions) from an ecommerce website. The orchestration agent may also generate a web_authoring_agent that receives the store data from the store_scraper_agent and generates a GUI website. The orchestration agent may also generate a goods_forwarding_agent where once goods are selected on the unified ecommerce application, the selected goods are forwarded and ordered on the respective website they are associated with (e.g., Walmart). The server-side orchestration agent may determine a time period based on the length of average browsing (e.g., 30 minutes), and causes a certificate authority to send a certificate to the personal computer for 30 minutes to facilitate the API calls from the personal computer to the API server. At 304, the API server transmits (via a SEND API call) the generated unified ecommerce application on the client device. The unified ecommerce application is also configured to have PUT and GET API calls for adding and removing items from a shopping cart on the unified ecommerce application. The client-side orchestration agent (e.g., EZBot) provides a UI textual message upon transmission of the SEND API call stating “Here is Walmart, Kroger, and Costco goods on a single storefront!”

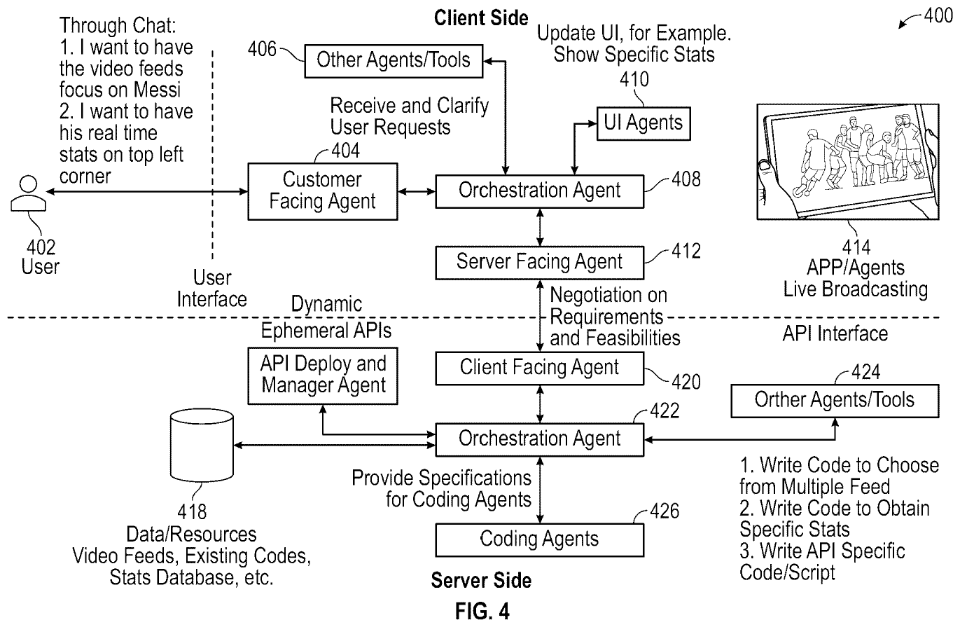

FIG. 4 shows an illustrative scenario 400 in which the system instantiates an API server to create a customized video feed for a sports match, in accordance with some embodiments of this disclosure. A tablet screen 414 (e.g., client device) generates a soccer match through a client-side application/agents. The application provides for a chatbot like user interface, where it may receive user input from a user 402 submitting requests to customize their viewing experience. Specifically, the customer facing agent 404 receives the following input from the user 402:
1. To have the video feed focus on Messi instead of the standard broadcast.
2. To display Messi's real-time statistics on the top left corner of the screen.
   Upon receiving the request, the client-side orchestration agent 408 of the application may negotiate and refine the request with the user before forwarding it to the customer facing agent 404 on the client side. The client-side orchestration agent 408 first determines (e.g., via other agents/tools 406) whether the requested feature is already available or can be fulfilled using existing APIs.
1. If existing APIs can handle the request, the client-side orchestration agent 408 will use the other agents/tools 406 to implement the requested functionality/feature with existing APIs
2. If no existing API is available, the server facing orchestration agent 412 negotiates with the client facing orchestration agent 420 on the server side to determine the feasibility of dynamically generating a new API.

At this point, the client facing agent 420 collaborates with the server-side orchestration agent 422 on the server to gather the necessary requirements or specifications for the new API. Once feasibility is confirmed and requirements are agreed upon, the server-side orchestration agent 422 coordinates with the coding agents 426 to implement and test the required API functionality. This may involve (may vary depending on the available resources/data):
1. Writing code to filter and isolate Messi's video feed from multiple camera angles (e.g., from data/resources 418 that include video feeds of Messi).
2. Writing code to fetch Messi's real-time performance statistics from the platform's sports analytics database. This may include use of other agents/tools 424 on the server side to aid in the coding.
3. Writing API-specific scripts to integrate the new functionality into the ephemeral API framework.
   Once the coding phase is complete, the API deploy and manage agent 416 performs the following functions:
1. Packages the API as a containerized microservice or serverless function.
2. Issues a short-lived TLS certificate to ensure secure access.
3. Deploys the new API endpoint dynamically, making it temporarily accessible for the client.

Upon successful deployment, the client facing agent 420 notifies the server facing agent 412 on the client side that the API is implemented. The client-side orchestration agent 408 updates the UI Agents 410, which integrate the new API functionality. The application now can receive a video feed, which adaptively switches among available feeds to the one that contains Messi, if such feed available. Additionally, the application may display Messi's live performance statistics in the top left corner of the screen. The server-side orchestration agent 422 may continue to monitor API usage based on predefined conditions. In some embodiments, the predefined conditions include: if the user stops watching, the game ends, or other conditions are met, the ephemeral API is no longer needed; or if the API exceeds its time-to-live (TTL), the server-side orchestration agent automatically deactivates the API. If these predefined conditions are triggered, the API deploy and manage agent 416 initiates the termination process that includes decommissioning the ephemeral API that removes allocation of the computing resources, revoking the short-lived TLS certificate ensuring the endpoint is no longer accessible, and updating the UI to reflect the API's removal returning to the default broadcast mode.

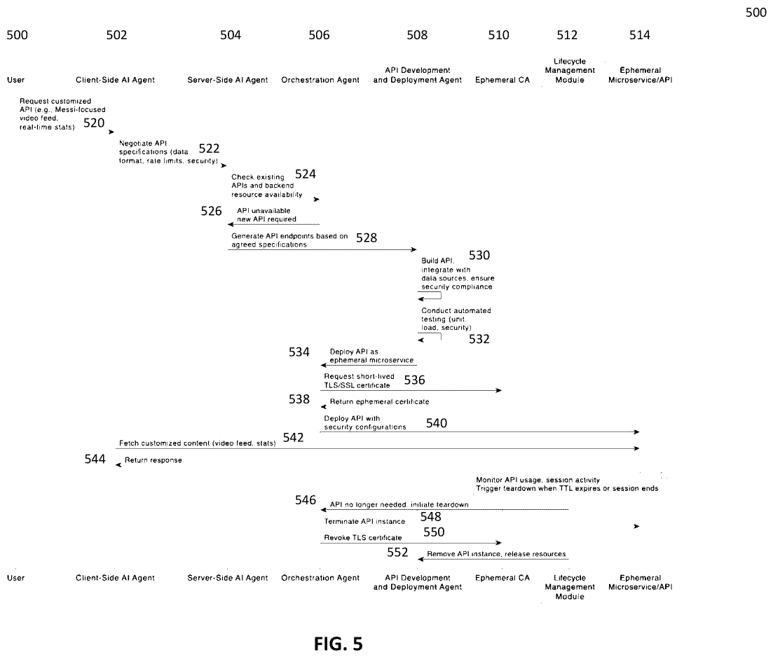

FIG. 5 is a sequence diagram 500 in which the system provides an ephemeral security certificate for an API server while providing customized content to a client device, in accordance with some embodiments of this disclosure. The sequence diagram includes a user (e.g., client device) 500, a client-side AI agent 502, a server-side AI agent 504, an orchestration agent 506, an API development and deployment agent 508, an ephemeral certificate authority 510, a lifecycle management module 512, and an ephemeral microservice/API 514. At 520, the client-side AI agent 502 receives a request customized API (e.g., Messi-focused video feed and real-time statistics) from the user 500 (similar to FIG. 1B where the client-side orchestration agent 114 receives a request 116 from the client device 112). At 522, the server-side AI agent 504 negotiates the API specification with the client-side AI agent 502 which may include data format, rate limits, and security specifications. At 524, the orchestration agent 506 checks the existing APIs with a database and computing resources (similar to FIG. 1B where the server-side orchestration agent identifies available computing resources 119). At 526, the orchestration agent 506 transmits to the server-side AI agent 504 that the API is unavailable, and a new API is required.

At 528, the API development and deployment agent 508 receives generated API endpoints based on specifications from the server-side AI agent 504. At 530, the API development and deployment agent 508 builds the API by integrating data sources and ensuring security compliance (similar to FIG. 1C where the API server 122 generates multiple AI agents to build the API). At 532, the API development and deployment agent 508 conducts automated testing such as testing unit load and security parameters. At 534, the API development and deployment agent 508 deploys the API as an ephemeral microservice to the orchestration agent 506. At 536, the orchestration agent 506 transmits a request to the ephemeral certificate authority 510 for a short-lived TLS/SSL certificate (similar to FIG. 1C where the server-side orchestration agent causes the certificate authority 121 to issue a security certificate). At 538, this request is granted, and the certificate is transmitted from the ephemeral certificate authority 510 to the orchestration agent 506. At 540, the ephemeral microservice API 514 receives the deployed API with security configuration from the orchestration agent 506 and, at 542, receives customized content (via fetch function) from the client-side AI agent 502. At 544, the client-side AI agent 504 receives a response to the fetch function.

The system may monitor API usage and session activity. This may be useful to trigger termination of the API when the security certificate expires or the session ends. At 546, the orchestration agent 506 receives instruction that the API is no longer needed and to commence termination. At 548, the orchestration agent 506 transmits a termination instance to the ephemeral microservice/API 514 and, at 550, the orchestration agent 506 revokes the security certificate from the ephemeral certificate authority 510 (similar to FIG. 1E where the server-side orchestration agent revokes the security certificate at 142 and terminates execution of the API server 144). At 552, the lifecycle management module 512 may remove the API instance and release the previously allocated computing resources.

In some embodiments, the negotiations between the server-side AI agent and client-side AI agent may include rate limits, authentication models, data schema definitions, and access control lists. In some embodiments, the negotiation can use any protocols other than natural language via chatbot. In the example used in FIG. 4, when the user requests a customized sports streaming experience—such as focusing the video feed on Messi and displaying his real-time statistics—the client-side AI agent initiates a negotiation process with the server-side AI agent to determine how to fulfill the request. The negotiation begins when the customer facing agent receives the user input through a chatbot-like interface and clarifies the request, ensuring that the user's intent is well-defined. Once the request is confirmed, the orchestration agent on the client side first checks whether the requested features can be fulfilled using existing APIs. If an existing API provides the necessary data (such as a general player statistics API or an alternative camera feed), the orchestration agent selects the appropriate API and passes the request to supporting agents/tools that implement the feature using pre-existing infrastructure.

If no existing API can fully meet the user's request, the server facing agent on the client side escalates the request to the client facing agent on the server side. The two agents establish a bidirectional communication channel, which could be a chatbot-like interface or another structured protocol, to negotiate API specifications dynamically. During this process, the client facing agent queries the server-side orchestration agent to assess the availability of required data streams and computational resources. The orchestration agent then consults video feed processing tools, real-time analytics engines, and existing sports data repositories to determine whether a new ephemeral API must be created. If feasible, the negotiation phase refines details such as data schema definitions, API rate limits, authentication models, and access control policies. For example, the server-side agent might confirm whether the camera feed can be analyzed to find Messi in real-time or if a player-tracking AI model needs to be deployed.

In some embodiments, the API design implemented by the API server and/or server-side AI agent may include an API design that includes endpoint paths, request/response structures, and security settings. This API design will enable the client-side agent to write the code in real-time to use the API to fulfill the task that it is asked to do. In one embodiment, the client side has multiple agents, and one agent is dedicated for communicating the requirements of the API and other agent can write the code, while yet other ones will be calling the API to perform the task. On the server side, this API design is handed off to the orchestration agent which will orchestrate the API development in real time and for live deployment.

Once the Server-Side AI Agent finalizes the negotiated API specifications, the API Development and Deployment Agents may generate, test, and deploy the ephemeral API instance. This process involves assessing the availability of backend resources, ensuring data integrity, and optimizing API performance based on real-time system constraints.

In some embodiments, the automatic development of the API may include the server-side AI agent querying various backend services to evaluate the availability of data and computational resources. To ensure that the API can fulfill its intended function, the server-side AI agent first determines whether the requested data exists in structured databases such as SQL and NoSQL, object stores, or real-time streaming sources. If the data is only partially available, the server-side AI agent suggests modifications to the API specification or attempts to retrieve alternate sources. In cases where data is unavailable, the server-side AI agent may implement fallback mechanisms, such as querying cached historical data or requesting external API integrations. Alongside data availability, the server-side AI agent evaluates computational resources to determine if the current server capacity can support the requested API. The server-side AI agent may check CPU and GPU workloads, assesses the feasibility of AI-driven data processing, and ensures that the API can be deployed in a cost-efficient cloud or edge environment. If resources are constrained, the server-side AI agent dynamically optimizes API processing by adjusting execution priorities or modifying query complexity to reduce load.

Upon completion of data and resource assessments, the API development agent (e.g., API server) proceeds to build the ephemeral API. The development process begins with API code generation, where the API development agent dynamically defines endpoints, request-response structures, and supported methods (such as GET, POST, PUT, and DELETE) based on client requirements and system constraints. The API logic is then adapted to match the available data schemas and backend capabilities. To ensure seamless data access, the API development agent configures data pipelines, integrating API endpoints with real-time or batch processing workflows. If data must be aggregated from multiple sources, merging logic is applied to streamline responses, and preprocessing modules are added where transformation is necessary. Security and access control mechanisms are implemented to ensure safe API operations, including the generation of short-lived authentication tokens, the configuration of rate-limiting policies, and the integration of ephemeral TLS certificates to protect API communication.

Before deployment, the API development agent conducts an automated validation process to confirm that the API functions correctly under various conditions. Unit testing verifies that request and response formats comply with predefined schemas while ensuring that input sanitization and error handling mechanisms are in place. Load testing simulates expected API traffic to assess scalability, optimizes query execution plans to prevent resource exhaustion, and deploys caching strategies to enhance response times for frequently accessed data. The API development agent also performs security testing, including penetration tests to detect vulnerabilities and confirm proper enforcement of access control policies. If an API fails validation, the API development agent initiates self-correction protocols, modifying request-response formatting based on error feedback, adjusting API logic to accommodate fallback data sources, and requesting additional computational resources if performance bottlenecks are identified. Once testing is successful, the API is finalized for deployment, ensuring it is optimized, secure, and ready for ephemeral use.

Upon finalization of the API design by the server-side AI agent, an API development agent is instantiated which may automatically implement the API on the server (e.g., generate API, perform testing, and conduct other API design requirements). In some embodiments, to deploy the API, another agent or pipeline could be used. It may begin with a base container image (for instance, a minimal Linux distribution combined with a desired runtime environment such as Node.js, Python, or Java), into which the required frameworks and libraries are injected according to the API blueprint. The orchestration agent next retrieves the generated source code from the coding API development agent and create a collection of configuration files (for example, environment variable files or Docker labels). For instance, it can store database connection strings, service endpoints, or authentication details. Security credentials such as API keys, OAuth tokens, or short-lived certificates are transferred through a secure secret management service rather than being embedded directly into container images. After these elements are assembled, the orchestration agent automatically generates a new container image, assigning it a unique version tag and depositing it into a repository such as Amazon ECR, Google Container Registry, or a private Harbor registry. Subsequently, the image undergoes vulnerability scanning to enforce compliance and meet security standards prior to its deployment.

In some embodiments, the build pipeline may implement a different container orchestration framework, or a custom tooling environment tailored to enterprise-specific requirements. In this scenario, the system may generate additional artifacts (including unit tests or compliance scripts) before the container image is finalized. Instead of storing these images in a commercial registry, organizations may rely on an on-premises repository that integrates with proprietary governance policies, ensuring that every build is audited and tracked according to internal security protocols.

Following the successful build, a deployment instruction referencing the newly created image version is issued to the orchestration agent, such as Kubernetes, Docker Swarm, AWS Fargate, or another container management solution. The orchestration agent then selects a suitable host node or serverless environment based on resource availability, geographical considerations, or autoscaling rules informed by CPU, memory, or custom metrics. At container startup, short-lived certificates issued by the Ephemeral certificate authority are mounted to enable secure HTTPS connectivity. Environment variables in the container define parameters such as time-to-live (TTL) or usage thresholds, so that a container remains operational only for a specified interval or until it processes a certain number of requests. Once deployed, a service proxy or ingress controller, for instance NGINX Ingress in Kubernetes, creates a temporary routing rule that associates an external hostname (like “api-<unique-hash>.example.com”) with the container's internal network address. DNS records are simultaneously updated, and the ephemeral certificate is associated with this domain to ensure its secure operation.

In some embodiments, the orchestration agent may forgo DNS updates in favor of an internal service mesh that employs a dynamic routing policy, thus assigning a virtual IP within a private network. Instead of ephemeral TLS certificates, an alternative short-lived mechanism—such as token-based mTLS—may be implemented for secure communication. Role-based access control (RBAC) may be implemented, ensuring that only the orchestration agent is authorized to schedule or terminate these ephemeral containers. Moreover, containers may operate within dedicated namespaces that confine them to a defined set of network routes or data storage options, offering a more stringent security model aligned with organizational or regulatory requirements.

When an ephemeral API is deployed, a server-side AI agent generates a unique cryptographic key pair corresponding to the API instance. This key pair is then sent to the ephemeral certificate authority, which signs it and returns a time-bound TLS certificate. The certificate is embedded directly into the API microservice, enabling secure HTTPS connections during its operational lifetime. Additionally, metadata constraints, such as expiration timestamps and domain bindings (e.g., apisession-xyz. example. com), are encoded within the certificate, ensuring strict access control. Each ephemeral API is issued a distinct certificate, preventing security risks associated with shared credentials across multiple instances. To facilitate end-to-end security, the client-side AI agent retrieves and verifies the ephemeral certificate before initiating API requests. The orchestration agent may implement automatic certificate expiration through multiple mechanisms. In some embodiments, a time-based expiration model is implemented ensuring that each issued certificate is valid only until the API reaches its predefined time-to-live (TTL) limit, at which point the orchestration agent monitors lifecycle events and triggers immediate revocation. In some embodiments, this predefined time-to-live (TTL) limit can also be negotiated before the ephemeral API is generated and deployed, for example, in the soccer live streaming case, the ephemeral certificate authority can expire when the live streaming game is over, and it does not have to be a fixed time, but driven by a negotiated event. In some embodiments, the expiry event for revocation may be negotiated between client-side and server-side subsequent to issuing the certificate.

In some embodiments, usage-based revocation may be implemented to prevent excessive or unauthorized access. If an API exceeds a predefined request threshold, the orchestration agent proactively revokes the certificate, rendering further access attempts invalid. In cases of detected security anomalies, such as unauthorized access attempts or suspicious traffic patterns, the ephemeral certificate authority immediately revokes the certificate to prevent potential misuse. A comprehensive logging mechanism documents revocation events, allowing for security audits and compliance tracking.

In some embodiments, once a certificate is revoked, its corresponding cryptographic keys are permanently removed from memory, eliminating the possibility of stale credentials persisting beyond the intended API lifespan. This automated certificate management process ensures that no ephemeral API remains accessible beyond its scheduled expiration, establishing secure connections without requiring persistent credentials. Each API instance operates within an isolated security boundary, preventing credential leakage across services.

In some embodiments, the API server may instantiate, for the ephemeral API, a dedicated health monitoring agent that continuously evaluates key performance metrics, including response times, availability status, and data integrity. Active health checks periodically verify the responsiveness of the API, allowing the orchestration engine to detect service degradation or unexpected failures. If an API instance becomes unresponsive or experiences latency spikes, the server-side orchestration agent initiates an automated recovery process. Depending on the severity of the issue, the server-side orchestration agent may attempt to restart the affected instance, deploy a duplicate API to redistribute traffic, or terminate the malfunctioning API entirely.

In some embodiments, the API server may implement real-time security event detection and automated anomaly response mechanisms. Each ephemeral API instance is continuously analyzed for suspicious access patterns, unauthorized authentication attempts, and abnormal request volumes. This may include the API server implementing of intrusion detection systems monitor incoming traffic for behavioral anomalies, such as repeated failed access attempts or access requests from unexpected geographic locations. When a potential security breach is detected, the orchestration engine enforces immediate countermeasures, including dynamically modifying access controls, throttling suspicious traffic or revoking API credentials.

In some embodiments, the API server may implement audit logging functionality to track all ephemeral API lifecycle events. Despite their transient nature, ephemeral APIs generate valuable operational and security insights, which are securely stored in a dedicated audit repository. Each API instantiation, access request, certificate issuance, security event, and termination action are recorded to provide forensic traceability and compliance documentation. This ensures that even after an ephemeral API has been retired, its operational history remains available for review, supporting regulatory compliance and incident investigations.

In some embodiments, the API server may dynamically adjust resource allocation based on real-time demand, leveraging adaptive scaling policies to optimize infrastructure utilization. If an ephemeral API experiences an unexpected surge in traffic, the system can instantly provision additional instances to handle the increased load. Conversely, if the system detects that an API is underutilized or has become idle, it pre-emptively schedules a teardown to free up computational resources. Predictive analytics help determine when an API is likely to become inactive, allowing the system to notify client-side agents before termination occurs, ensuring a seamless transition without disrupting user workflows.

In some embodiments, even though an API may be generated by the API server to be ephemeral, in certain circumstances the parameters may be adjusted to maintain persistence of the API. In this scenario, the time period would be adjusted to a prolonged period or set to infinite until a non-temporal condition is met for termination (e.g., fulfilment of the task).

In some embodiments, the described systems and method may be applied to advertising technology, where AI agents negotiate customized, campaign-specific API specifications between advertisers, demand-side platforms (DSPs), and supply-side platforms (SSPs). Advertising campaigns often require highly customized targeting criteria, such as specific audience segments, real-time bidding parameters, and geographic or contextual constraints. The client-side AI agent communicates with the server-side AI agent to determine API parameters, and upon agreement, the system dynamically deploys an ephemeral API to fetch relevant ads for the session.

In some embodiments, the described systems and method may be applied to financial market data APIs, where traders request custom, ephemeral APIs to fetch real-time stock trends, risk analysis, and AI-driven insights, including technical and fundamental analysis results. The server-side orchestration agent negotiates API requirements, provisions secure financial data feeds, and revokes access upon API expiration. This prevents data persistence risks, unauthorized access, and unnecessary computational overhead, making financial analytics highly adaptive.

In some embodiments, the described systems and method may be applied to enabling on-demand software as a service (Saas) customization, allowing enterprise clients to generate ephemeral APIs that temporarily extend application functionality based on user needs. These APIs integrate client-specific workflows, data processing logic, and security policies, existing only for the duration of a session or business transaction, ensuring flexibility without persistent overhead.

In some embodiments, the described systems and methods may be applied to cybersecurity and access-controlled APIs, where short-lived APIs provide temporary authentication, adaptive access control, and zero-trust security models. APIs are provisioned only when a user session requires it, with ephemeral TLS certificates enforcing strict, time-bound access. Upon session termination, the API is revoked, ensuring zero residual attack vectors.

In some embodiments, the described systems and method may be applied to AI-driven software testing and development, where dynamically generated APIs simulate test environments, service mocks, and isolated debugging sessions. APIs are instantiated for testing, with automatic expiration after validation, reducing long-term maintenance burdens and infrastructure waste.

In some embodiments, the described systems and method may be applied to healthcare and medical data APIs, where ephemeral APIs handle temporary patient data access for AI-driven diagnostics and telemedicine applications. APIs are deployed based on real-time consultation needs and securely decommissioned after the session, ensuring HIPAA-compliant, zero-data retention policies while minimizing attack surfaces.

FIGS. 6-7 describe illustrative devices, systems, servers, and related hardware for a media application for efficient navigation of a plurality of media assets and for playing post-credit content in media assets by overriding play-next logic, in accordance with some embodiments of this disclosure. FIG. 6 shows generalized embodiments of illustrative user devices 600 and 601. For example, user equipment device 600 may be a smartphone device, a tablet, smart glasses, a virtual reality or augmented reality device (e.g., AR goggles, AR headset, AR implemented via smartphone, tablet, or computer), or any other suitable device capable of consuming media assets and capable of transmitting and receiving data over a communication network. In another example, user equipment device 601 may be a user television equipment system or device. User television equipment device 601 may include set-top box 615. Set-top box 615 may be communicatively connected to microphone 616, audio output equipment (e.g., speaker or headphones 614), and display 612. In some embodiments, microphone 616 may receive audio corresponding to a voice of a user, e.g., a voice command. In some embodiments, display 612 may be a television display or a computer display. In some embodiments, set-top box 615 may be communicatively connected to user input interface 610. In some embodiments, user input interface 610 may be a remote-control device. Set-top box 615 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of user equipment devices are discussed below in connection with FIG. 7. In some embodiments, device 600 may comprise any suitable number of sensors, as well as a GPS module (e.g., in communication with one or more servers and/or cell towers and/or satellites) to ascertain a location of device 600.

Each one of user equipment device 600 and user equipment device 601 may receive content and data via input/output (I/O) path 602. I/O path 602 may provide content (e.g., broadcast programming, on-demand programming, Internet content, content available over a local area network (LAN) or wide area network (WAN), and/or other content) and data to control circuitry 604, which may comprise processing circuitry 606 and storage 608. Control circuitry 604 may be used to send and receive commands, requests, and other suitable data using I/O path 602, which may comprise I/O circuitry. I/O path 602 may connect control circuitry 604 (and specifically processing circuitry 606) to one or more communications paths (described below). I/O functions may be provided by one or more of these communications paths but are shown as a single path in FIG. 7 to avoid overcomplicating the drawing. While set-top box 615 is shown in FIG. 7 for illustration, any suitable computing device having processing circuitry, control circuitry, and storage may be used in accordance with the present disclosure. For example, set-top box 615 may be replaced by, or complemented by, a personal computer (e.g., a notebook, a laptop, a desktop), a smartphone (e.g., device 600), a tablet, a network-based server hosting a user-accessible user device, a non-user-owned device, any other suitable device, or any combination thereof.

Control circuitry 604 may be based on any suitable control circuitry such as processing circuitry 606. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i9 processors) or multiple different processors (e.g., an Intel Core i9 processor and an Intel Core i9 processor). In some embodiments, control circuitry 604 executes instructions for the Media application stored in memory (e.g., storage 608). Specifically, control circuitry 604 may be instructed by the Media application to perform the functions discussed above and below. In some implementations, processing or actions performed by control circuitry 604 may be based on instructions received from the Media application.

In client/server-based embodiments, control circuitry 604 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a DRAM integrated circuit, read-only memory on a BLU-RAY disk, etc.). For example, in FIG. 7, the instructions may be stored in storage 608 and executed by control circuitry 604 of a device 600.

In some embodiments, the media application may be a client/server application where only the client application resides on device 600, and a server application resides on an external server (e.g., server 704). For example, the media application may be implemented partially as a client application on control circuitry 604 of device 600 and partially on server 704 as a server application running on control circuitry 711. Server 704 may be a part of a local area network with one or more of devices 600 or may be part of a cloud computing environment accessed via the internet. In a cloud computing environment, various types of computing services for performing searches on the internet or informational databases, providing storage (e.g., for a database 705) or parsing data are provided by a collection of network-accessible computing and storage resources (e.g., server 704), referred to as “the cloud.” Device 600 may be a cloud client that relies on the cloud computing capabilities from server 704 to determine whether processing should be offloaded and facilitate such offloading. When executed by control circuitry 604 or 711, the media application may instruct control circuitry 604 or 711 circuitry to perform processing tasks for the user device and facilitate a media consumption session integrated with social network services. The client application may instruct control circuitry 604 to determine whether processing should be offloaded.

Control circuitry 604 may include communications circuitry suitable for communicating with a server, social network service, a table or database server, or other networks or servers. The instructions for carrying out the above-mentioned functionality may be stored on a server (which is described in more detail in connection with FIG. 7). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 7). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as media application data described above. Nonvolatile memory may also be used (e.g., to launch a boot-up routine and other instructions). Cloud-based storage may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and down converting content into the preferred output format of user equipment 600. Control circuitry 604 may also include digital-to-analog converter circuitry and analog-to-digital converter circuitry for converting between digital and analog signals. The tuning and encoding circuitry may be used by user equipment device 600, 601 to receive and to display, to play, or to record content. The tuning and encoding circuitry may also be used to receive media consumption data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment device 600, the tuning and encoding circuitry (including multiple tuners) may be associated with storage 608.

Control circuitry 604 may receive instruction from a user by way of user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of each one of user equipment device 600 and user equipment device 601. For example, display 612 may be a touchscreen or touch-sensitive display. In such circumstances, user input interface 610 may be integrated with or combined with display 612. In some embodiments, user input interface 610 includes a remote-control device having one or more microphones, buttons, keypads, any other components configured to receive user input or combinations thereof. For example, user input interface 610 may include a handheld remote-control device having an alphanumeric keypad and option buttons. In a further example, user input interface 610 may include a handheld remote-control device having a microphone and control circuitry configured to receive and identify voice commands and transmit information to set-top box 615.

Audio output equipment 614 may be integrated with or combined with display 612. Display 612 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 612. Audio output equipment 614 may be provided as integrated with other elements of each one of device 600 and equipment 601 or may be stand-alone units. An audio component of videos and other content displayed on display 612 may be played through speakers (or headphones) of audio output equipment 614. In some embodiments, audio may be distributed to a receiver (not shown), which processes and outputs the audio via speakers of audio output equipment 614. In some embodiments, for example, control circuitry 604 is configured to provide audio cues to a user, or other audio feedback to a user, using speakers of audio output equipment 614. There may be a separate microphone 616 or audio output equipment 614 may include a microphone configured to receive audio input such as voice commands or speech. For example, a user may speak letters or words that are received by the microphone and converted to text by control circuitry 604. In a further example, a user may voice commands that are received by a microphone and recognized by control circuitry 604. Camera 618 may be any suitable video camera integrated with the equipment or externally connected. Camera 618 may be a digital camera comprising a charge-coupled device (CCD) and/or a complementary metal-oxide semiconductor (CMOS) image sensor. Camera 618 may be an analog camera that converts to digital images via a video card.

The media application may be implemented using any suitable architecture. For example, it may be a stand-alone application wholly-implemented on each one of user equipment device 600 and user equipment device 601. In such an approach, instructions of the application may be stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to provide media consumption and social network interaction functionality and generate any of the displays discussed herein. Based on the processed instructions, control circuitry 604 may determine what action to perform when input is received from user input interface 610. For example, movement of a cursor on a display up/down may be indicated by the processed instructions when user input interface 610 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 604 may allow a user to provide user profile information or may automatically compile user profile information. For example, control circuitry 604 may access and monitor network data, video data, audio data, processing data, participation data from a media application and social network profile. Control circuitry 604 may obtain all or part of other user profiles that are related to a particular user (e.g., via social media networks), and/or obtain information about the user from other sources that control circuitry 604 may access. As a result, a user can be provided with a unified experience across the user's different devices.

In some embodiments, the media application is a client/server-based application. Data for use by a thick or thin client implemented on each one of user equipment device 600 and user equipment device 601 may be retrieved on-demand by issuing requests to a server remote to each one of user equipment device 600 and user equipment device 601. For example, the remote server may store the instructions for the application in a storage device. The remote server may process the stored instructions using circuitry (e.g., control circuitry 604) and generate the displays discussed above and below. The user device may receive the displays generated by the remote server and may display the content of the displays locally on device 600. This way, the processing of the instructions is performed remotely by the server while the resulting displays (e.g., that may include text, a keyboard, or other visuals) are provided locally on device 600. Device 600 may receive inputs from the user via input interface 610 and transmit those inputs to the remote server for processing and generating the corresponding displays. For example, device 600 may transmit a communication to the remote server indicating that an up/down button was selected via input interface 610. The remote server may process instructions in accordance with that input and generate a display of the application corresponding to the input (e.g., a display that moves a cursor up/down). The generated display may then be transmitted to device 600 for presentation to the user.

In some embodiments, the media application may be downloaded and interpreted or otherwise run by an interpreter or virtual machine (run by control circuitry 604). In some embodiments, the media application may be encoded in the ETV Binary Interchange Format (EBIF), received by control circuitry 604 as part of a suitable feed, and interpreted by a user agent running on control circuitry 604. For example, the media application may be an EBIF application. In some embodiments, the media application may be defined by a series of JAVA-based files that are received and run by a local virtual machine or other suitable middleware executed by control circuitry 604. In some of such embodiments (e.g., those employing MPEG-2 or other digital media encoding schemes), the media application may be, for example, encoded and transmitted in an MPEG-2 object carousel with the MPEG audio and video packets of a program.

FIG. 7 is a diagram of an illustrative system 700, in accordance with some embodiments of this disclosure. User equipment devices 707, 708, 709, 710 (e.g., client device 112 of FIG. 1A-E; devices or any other suitable devices, or any combination thereof) may be coupled to communication network 706. Communication network 706 may be one or more networks including the Internet, a mobile phone network, mobile voice or data network (e.g., a 5G, 4G, or LTE network, or any other suitable network or any combination thereof), cable network, public switched telephone network, or other types of communication network or combinations of communication networks. Paths (e.g., depicted as arrows connecting the respective devices to the communication network 706) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the user devices may be provided by one or more of these communications paths but are shown as a single path in FIG. 7 to avoid overcomplicating the drawing. In some embodiments, an email sender server 730 is communicatively coupled, via the communication network 706, to server 704. In some embodiments, a domain name system server 732 is communicatively coupled, via the communication network 706, to server 704.

Although communications paths are not drawn between user equipment devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The user equipment devices may also communicate with each other directly through an indirect path via communication network 706.

System 700 may comprise media content source 702, one or more servers 704, and one or more social network services. In some embodiments, the media application may be executed at one or more of control circuitry 711 of server 704 (and/or control circuitry of user equipment devices 707, 708, 709, 710.

In some embodiments, server 704 may include control circuitry 711 and storage 714 (e.g., RAM, ROM, Hard Disk, Removable Disk, etc.). Instructions for the media application may be stored in storage 714. In some embodiments, the media application, via control circuitry, may execute functions outlined in FIGS. 1-5. Storage 714 may store one or more databases. Server 704 may also include an input/output path 712. I/O path 712 may provide media consumption data, social media data, device information, or other data, over a local area network (LAN) or wide area network (WAN), and/or other content and data to control circuitry 711, which may include processing circuitry, and storage 714. Control circuitry 711 may be used to send and receive commands, requests, and other suitable data using I/O path 712, which may comprise I/O circuitry. I/O path 712 may connect control circuitry 711 (and specifically control circuitry) to one or more communications paths. I/O path 712 may comprise I/O circuitry.

Control circuitry 711 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 711 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 711 executes instructions for an emulation system application stored in memory (e.g., the storage 714). Memory may be an electronic storage device provided as storage 714 that is part of control circuitry 711.

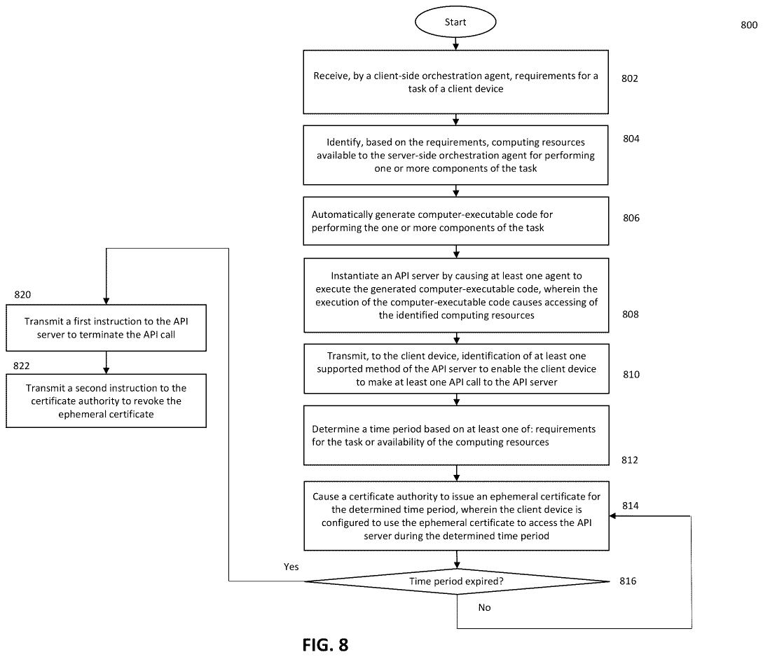

FIG. 8 is a flowchart of a detailed illustrative process for causing a certificate authority to issue an ephemeral certificate for the determined time period during instantiation of an API server, in accordance with some embodiments of this disclosure. In various embodiments, the individual steps of process 800 may be implemented by one or more components of the devices and systems of FIGS. 1-7. Although the present disclosure may describe certain steps of process 800 (and of other processes described herein) as being implemented by certain components of the devices and systems of FIGS. 1-7, this is for purposes of illustration only, and it should be understood that other components of the devices and systems of FIGS. 1-7 may implement those steps instead.

At 802, the server-side orchestration agent, via a control circuitry (e.g., control circuitry 711 of FIG. 7), receives, by a client-side orchestration agent, requirements for a task for a client device. In some embodiments, the server-side orchestration agent interfaces with client-side orchestration agent via control circuitry. In some embodiments, the server-side orchestration agent interfaces with client-side orchestration agent via an I/O path (e.g., I/O path 712) over a communication network (e.g., communication network 706). In some embodiments, the server-side orchestration agent interfaces with the conversational AI system via control circuitry. In some embodiments, the server-side orchestration agent interfaces with the conversational AI system via an I/O path over a communication network.

At 804, the server-side orchestration agent, via a control circuitry, identifies, based on the requirements, computing resources available to the server-side orchestration agent for performing one or more components of the task. In some embodiments, the identification implements communication via an I/O path over a communication network to user equipment (e.g., user equipment 707, 708, 709, or 710). In some embodiments, the identification interfaces with storage (e.g., storage 714 or database 705).

At 806, the server-side orchestration agent, via a control circuitry, automatically generates computer-executable code for performing the one or more components of the task. At 808, the server-side orchestration agent, via a control circuitry, instantiates an API server by causing at least one agent to execute the generated computer-executable code. The execution of the computer-executable code causes accessing of the identified computing resources. In some embodiments, the accessing of the identified computing resources includes interfacing with media content sources (e.g., media content source 728).

At 810, the server-side orchestration agent, via a control circuitry, transmits, to the client device, identification of at least one supported method of the API server to enable the client device to make at least one API call to the API server. In some embodiments, the transmission is via the I/O path over the communication network to a user equipment.

At 812, the server-side orchestration agent, via a control circuitry, determines a time period based on at least one of: requirements for the task or availability of the computing resources. At 814, the server-side orchestration agent, via a control circuitry, causes a certificate authority to issue an ephemeral certificate for the determined time period, wherein the client device is configured to use the ephemeral certificate to access the API server during the determined time period. In some embodiments, the server-side orchestration agent interfaces with the certificate authority via the I/O path over the communication network.

If, at 816, the server-side orchestration agent, via a control circuitry, determines that determined time period is not expired, the process reverts to step 814. If, at 816, the server-side orchestration agent, via a control circuitry, determines that determined time period is expired, the process proceeds to step 820.

At 820, the server-side orchestration agent, via a control circuitry, transmits a first instruction to the API server to terminate the API call. In some embodiments, the server-side orchestration agent transmits the first instruction to the API server via control circuitry. In some embodiments, the server-side orchestration agent transmits the first instruction to the API server via an I/O path over a communication network.

At 822, the server-side orchestration agent, via a control circuitry, transmits a second instruction to the certificate authority to revoke the ephemeral certificate. In some embodiments, the server-side orchestration agent transmits the second instruction to the certificate authority an I/O path over a communication network.

The processes discussed above are intended to be illustrative and not limiting. One skilled in the art would appreciate that the steps of the processes discussed herein may be omitted, modified, combined and/or rearranged, and any additional steps may be performed without departing from the scope of the disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, from a client-side orchestration agent, requirements for a task of a client device;
identifying, based on the requirements, computing resources available to a server-side orchestration agent for performing one or more components of the task;
automatically generating computer-executable code for performing the one or more components of the task;
instantiating, by the server-side orchestration agent, an API server by causing at least one agent to execute the generated computer-executable code, wherein the execution of the computer-executable code causes accessing of the identified computing resources;
transmitting, to the client device, identification of at least one supported method of the API server to enable the client device to make at least one API call to the API server;
determining a time period based on at least one of the requirements for the task, or availability of the computing resources; and
causing a certificate authority to issue an ephemeral certificate for the determined time period, wherein the client device is configured to use the ephemeral certificate to access the API server during the determined time period.

2. The method of claim 1, further comprising:
monitoring for the at least one API call from the client device to the API server; and
based on a determination that no API calls from the client device associated with the task were made to the API server for a particular period of time, causing the certificate authority to revoke the ephemeral certificate before expiration of the determined time period.

3. The method of claim 1, further comprising:
identifying an unauthorized API call associated with the task to the API server; and
based on the identifying the unauthorized API call associated with the task to the API server, causing the certificate authority to revoke the ephemeral certificate before expiration of the determined time period.

4. The method of claim 1, further comprising:
based on an expiration of the time period:
causing the certificate authority to revoke the ephemeral certificate; and
terminating the instance of the API server.

5. The method of claim 1, wherein the requirements for the task specified a prospective component of the task, the method further comprising:
determining, by the server-side orchestration agent, a lack of computing resources for the prospective component of the task;
transmitting, to the client device, an indication indicating the lack of computing resources for the prospective component of the task;
wherein the transmitting the indication causes the client device to:
generate a proposal of an altered prospective component of the task; and
receive a user interface confirmation from the client device to proceed with the task based on the proposal of the altered prospective component of the task.

6. The method of claim 1, wherein the transmitting, to the client device, the identification of at least one supported method of the API server comprises identification of at least one of: a GET method related to at least one endpoint of the API server; a POST method related to at least one endpoint of the API server; a PUT method related to at least one endpoint of the API server; or a DELETE method related to at least one endpoint of the API server.

7. The method of claim 1, wherein the execution of the computer-executable code that causes accessing of the identified computing resources comprises:
accessing one or more networked connected computing resources, wherein the one or more network connected computing resources comprise at least one of control circuitry, processing circuitry, memory, or network connectivity to perform at least one or more components of the task.

8. The method of claim 1, wherein the execution of the computer-executable code that causes accessing of the identified computing resources comprises:
identifying, by the server-side orchestration agent, a lack of computing resources for a prospective component of the task; and
transmitting a request to another server-side orchestration agent on another server to instantiate another API server for providing other resources;
wherein the accessing of the identified computing resources comprises accessing other resources from the other API server.

9. The method of claim 1, further comprising:
storing the generated computer-executable code in a database;
receiving, from the client-side orchestration agent, second requirements for a second task from a second client device;
identifying, based on the second requirements, a second set of computing resources available to the server-side orchestration agent for performing the one or more components of the second task;
determining whether the second requirements for the second task corresponds to the generated computer-executable code in the database;
in response to the second requirements for the second task corresponding to the generated computer-executable code in the database:
retrieving the generated computer-executable code in the database; and
instantiating, by the server-side orchestration agent, a second API server by causing at least one agent to execute the stored computer-executable code.

10. The method of claim 1, wherein:
a requirement for the task is to provide a sporting event video stream following a particular player;
the automatically generating the computer-executable code comprises:
generating code for accessing a plurality of video feeds of the sporting event;
generating code for analyzing the plurality of video feeds to identify, for each timestamp of a plurality of timestamps, a respective particular video feed that comprises an image of the particular player;
generating code for creating an output stream by collating portions of each respective particular video feed based on the analyzing the plurality of video feeds; and
the API server is configured to provide a manifest for accessing the created output stream.

11. A system comprising:
control circuitry configured to:
receive, from a client-side orchestration agent, requirements for a task of a client device;
identify, based on the requirements, computing resources available to a server-side orchestration agent for performing one or more components of the task;
automatically generate computer-executable code for performing the one or more components of the task;
instantiate, by the server-side orchestration agent, an API server by causing at least one agent to execute the generated computer-executable code, wherein the execution of the computer-executable code causes accessing of the identified computing resources;
transmit, to the client device, identification of at least one supported method of the API server to enable the client device to make at least one API call to the API server;
determine a time period based on at least one of the requirements for the task, or availability of the computing resources; and
cause a certificate authority to issue an ephemeral certificate for the determined time period, wherein the client device is configured to use the ephemeral certificate to access the API server during the determined time period.

12. The system of claim 11, wherein the system is further configured to:
monitor for the at least one API call from the client device to the API server; and
based on a determination that no API calls from the client device associated with the task were made to the API server for a particular period of time, cause the certificate authority to revoke the ephemeral certificate before expiration of the determined time period.

13. The system of claim 11, wherein the system is further configured to:
identify an unauthorized API call associated with the task to the API server; and
based on the identifying the unauthorized API call associated with the task to the API server, cause the certificate authority to revoke the ephemeral certificate before expiration of the determined time period.

14. The system of claim 11, wherein the system is further configured to:
based on an expiration of the time period:
cause the certificate authority to revoke the ephemeral certificate; and
terminate instance of the API server.

15. The system of claim 11, wherein the requirements for the task specified a prospective component of the task, and the system is further configured to:
determine, by the server-side orchestration agent, a lack of computing resources for the prospective component of the task;
transmit, to the client device, an indication indicating the lack of computing resources for the prospective component of the task;
wherein the transmitting the indication causes the client device to:
generate a proposal of an altered prospective component of the task; and
receive a user interface confirmation from the client device to proceed with the task based on the proposal of the altered prospective component of the task.

16. The system of claim 11, wherein the transmitting, to the client device, the identification of at least one supported method of the API server comprises identification of at least one of: a GET method related to at least one endpoint of the API server; a POST method related to at least one endpoint of the API server; a PUT method related to at least one endpoint of the API server; or a DELETE method related to at least one endpoint of the API server.

17. The system of claim 11, wherein the system is configured, when executing the computer-executable code that causes accessing of the identified computing resources, to:
access one or more networked connected computing resources, wherein the one or more network connected computing resources comprise at least one of control circuitry, processing circuitry, memory, or network connectivity to perform at least one or more components of the task.

18. The system of claim 11, wherein the system is configured, when executing the computer-executable code that causes accessing of the identified computing resources, to:
identify, by the server-side orchestration agent, a lack of computing resources for a prospective component of the task; and
transmit a request to another server-side orchestration agent on another server to instantiate another API server for providing other resources;
wherein the accessing of the identified computing resources comprises accessing other resources from the other API server.

19. The system of claim 11, wherein the system is further configured to:
store the generated computer-executable code in a database;
receive, from the client-side orchestration agent, second requirements for a second task from a second client device;
identify, based on the second requirements, a second set of computing resources available to the server-side orchestration agent for performing the one or more components of the second task;
determine whether the second requirements for the second task corresponds to the generated computer-executable code in the database;
in response to the second requirements for the second task corresponding to the generated computer-executable code in the database:
retrieve the generated computer-executable code in the database; and
instantiate, by the server-side orchestration agent, a second API server by causing at least one agent to execute the stored computer-executable code.

20. The system of claim 11, wherein:
a requirement for the task is to provide a sporting event video stream following a particular player;
the system, when automatically generating the computer-executable code, is configured to:
generate code for accessing a plurality of video feeds of the sporting event;
generate code for analyzing the plurality of video feeds to identify, for each timestamp of a plurality of timestamps, a respective particular video feed that comprises an image of the particular player;
generate code for creating an output stream by collating portions of each respective particular video feed based on the analyzing the plurality of video feeds; and
the API server is configured to provide a manifest for accessing the created output stream.

21-50. (canceled)
